(19) United States
(12) Patent Application Publication
(10) Pub. No.: US 2021/0157855 A1
(43) Pub. Date: May 27, 2021

(54) PASSAGE VERIFICATION USING A FACTOID QUESTION ANSWER SYSTEM

(71) Applicant: International Business Machines Corporation, Armonk, NY (US)

(72) Inventors: Stephen Arthur Boxwell, Franklin, OH (US); Keith Gregory Frost, Delaware, OH (US); Kyle Matthew Brake, Westerville, OH (US); Stanley John Vernier, Grove City, OH (US)

(21) Appl. No.: 16/690,161

(22) Filed: Nov. 21, 2019

(51) Int. Cl. G06F 16/9032; G06F 40/49

(52) U.S. Cl. CPC G06F 16/90332; G06F 40/49; G06F 16/90324

(57) ABSTRACT

A method, system, and computer program product to verify components of a statement and suggest substitute components using a factoid question answer system. The method may include receiving an input statement, where the input statement comprises a plurality of natural language words. The method may also include determining one or more replacement candidates for the input statement. The method may also include generating one or more candidate answers for each replacement candidate of the one or more replacement candidates. The method may also include mapping, as a replacement candidate—candidate answer mapping, each candidate answer from the one or more candidate answers to its corresponding replacement candidate. The method may also include determining a replacement score for each replacement candidate—candidate answer mapping. The method may also include transmitting an output including one or more suggested replacements and the replacement score to a user interface.

### BACKGROUND

The present disclosure relates to factoid question answer systems and natural language processing, and more specifically to verifying components of a statement and suggesting substitute components.

Question answer (QA) systems are used to generate answers for questions inputted to a computer in natural language. A QA system may query a structured database (e.g., a knowledge base) and/or extract relevant data from an unstructured collection of natural language documents, and the extracted data and/or the data from the structured database is used to generate a natural language answer to the query. In some instances, the inputted question may be factoid based. Factoids may be unverified information that has been presented as fact. QA systems that are equipped to answer factoid based questions are referred to herein as factoid QA systems.

### SUMMARY

The present disclosure provides a computer-implemented method, system, and computer program product to verify components of a statement and suggest substitute components using a factoid question answer system. The method may include receiving an input statement, where the input statement comprises a plurality of natural language words. The method may also include determining one or more replacement candidates for the input statement. The method may also include generating one or more candidate answers for each replacement candidate of the one or more replacement candidates. The method may also include mapping, as a replacement candidate—candidate answer mapping, each candidate answer from the one or more candidate answers to its corresponding replacement candidate. The method may also include determining a replacement score for each replacement candidate—candidate answer mapping. The method may also include transmitting an output including one or more suggested replacements and the replacement score to a user interface, where the suggested replacement corresponds at least the replacement candidate and its corresponding candidate answer. The system and computer program product may include similar steps.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a flowchart of a set of operations for verifying components of a statement and suggesting substitute components, according to some embodiments.

FIG. 2 depicts a flowchart of a set of operations for determining a replacement score for each corresponding replacement candidate and candidate answer, according to some embodiments.

FIG. 3 depicts a schematic diagram of a factoid question answer (QA) system, according to some embodiments.

FIG. 4 depicts a schematic diagram of a user interface displaying suggested substitute components, according to some embodiments.

FIG. 5 depicts a block diagram of a sample computer system, according to some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to factoid question answer systems and natural language processing, and more specifically to verifying components of a statement and suggesting substitute components. While the present disclosure is not necessarily limited to such applications, various aspects of the disclosure may be appreciated through a discussion of various examples using this context.

In conventional question answer (QA) tasks, factoid-based questions may be asked and a short answer may be determined. Factoid-based questions may revolve around facts and may be about providing facts. For instance, a factoid-based question may be a request for factual information. Examples of factoid based questions include: “Is the sky blue?”, “Who is the quarterback of the New England Patriots?”, “Does June have 31 days in the month?”, etc. Conventionally, these questions, when inputted into a QA system, may have short and simple outputs, such as “yes” or “no,” and/or a brief statement with the fact that answers the inputted question. In some instances, the output may include a clarifying statement. For example, if the question inputted is “Is Aaron Rogers the quarterback of the New England Patriots?” the output from the QA system may state “Aaron Rogers is the quarterback of the Green Bay Packers,” “Tom Brady is the quarterback of the New England Patriots,” or a combination of the two example outputs. In some embodiments, the output may include both a yes/no statement and a clarifying statement.

In some instances, a user might come across a passage/statement (for example, when analyzing documents) that requires verification or further investigation. For example, a user may want to further verify a statement such as “The first man on the moon, Charles Lindbergh, landed at the Sea of Tranquility on Jul. 20, 1969.” In a conventional factoid QA system, in order to verify the statement, a user may have to break down the statement into a series of questions to input into the QA system. For example, a user may have to break down the statement into questions including “Who was the first man on the moon?”, “Who landed on the moon on Jul. 20, 1969?”, “Did Charles Lindbergh land on the moon?”, “Where did Charles Lindbergh land?”, etc. The QA system may have to analyze each input question separately, even though each question may be related, and may have to transmit separate outputs for each input question. This may be inefficient for the QA system, as it may take up more time and bandwidth to analyze each question separately. Accessing a QA system can involve using a computer network, which can be constrained by the amount of bandwidth. Bandwidth can represent a volume of data passing over the network. Thus, repeated accesses can be an inefficient use of the limited resource of network bandwidth. For example, questions like “Who was the first man on the moon?” and “Who landed on the moon on Jul. 20, 1969” may use the same, or at least similar, corpuses of data in order to determine the answer. However, the QA system may have to re-access the data corpus for each input question, using up additional bandwidth.

Additionally, it may be up to the user to determine which questions are necessary to input into the QA system in order to obtain the verification they need, which may result in some user error and incorrect questions being inputted. This may further be inefficient for the QA system, because the QA system may have to repeatedly run queries for different input questions until the correct questions are asked in order for the user to obtain the necessary verification.

The present disclosure provides a computer-implemented method, system, and computer program product to verify components of a statement and suggest substitute components using a factoid question answer system. Instead of separating a statement (for verification) into various questions, the whole statement may be submitted. Continuing the example above, the whole statement “The first man on the moon, Charles Lindbergh, landed at the Sea of Tranquility on Jul. 20, 1969” may be inputted into the QA system (e.g., a factoid QA system). The QA system may identify any relevant documents from a corpus that may support or contradict the statement. For example, for the above statement, the corpus may return relevant documents or phrases including:

“Neil Armstrong and Buzz Aldrin landed, on Jul. 20, 1969, at the Sea of Tranquility.”

“Charles Lindbergh was the first transatlantic flight pilot and landed at Le Bourguet Field on May 21, 1927.”

“Neil Armstrong, Buzz Aldrin, and Michael Collins landed back on Earth on Jul. 24, 1969.”

These statements may be analyzed in order to determine whether any replacements/substitutions are needed for the original input statement. Based on the analysis, the QA system may output suggested substitutions, along with confidence scores of the suggested substitutions. The confidence scores may indicate the confidence of the system in the accuracy of the suggested substitutions. Based on the above example relevant documents/phrases, the QA system may output substitutions such as:

1. Charles Lindbergh→Neil Armstrong (0.98)

2. Charles Lindbergh→Buzz Aldrin (0.92)

3. man on the moon→transatlantic flight pilot (0.70)

4. Sea of Tranquility→Le Bourguet Field (0.55)

Based on the example outputs, it may be determined that the initial statement, “The first man on the moon, Charles Lindbergh, landed at the Sea of Tranquility on Jul. 20, 1969” is not fully accurate, and, to make the statement accurate, “Charles Lindbergh” may be replaced with “Neil Armstrong.” Replacing “Charles Lindbergh” with “Neil Armstrong” may have a 0.98 confidence score of the substitution, which may indicate that the system is 98% confident that the statement including “Neil Armstrong” (instead of “Charles Lindbergh”) is accurate.

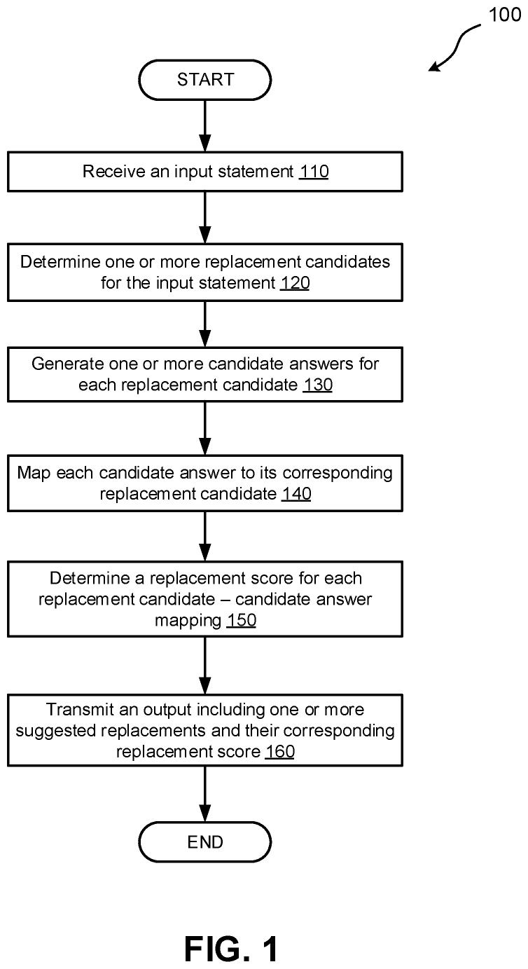

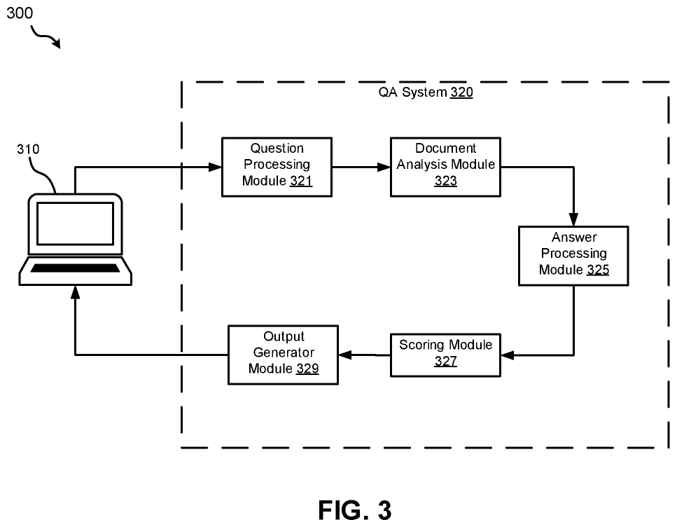

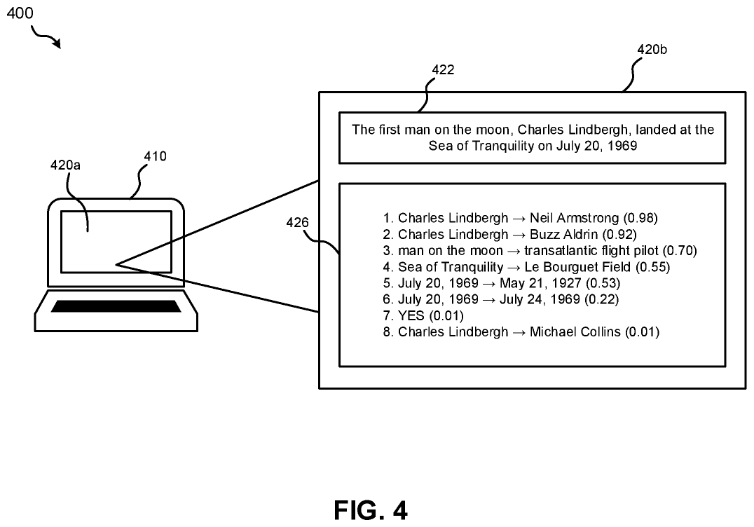

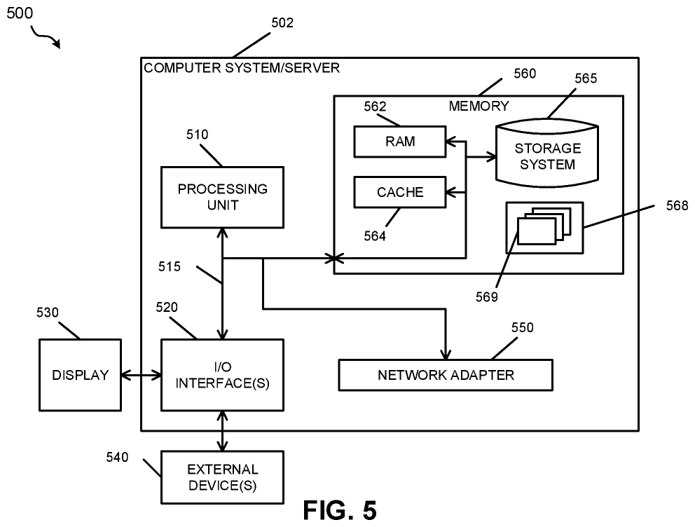

Referring now to FIG. 1, a flowchart illustrating a method 100 for verifying components of a statement and suggesting substitute components is depicted, according to some embodiments. In some embodiments, method 100 is executed by a server (e.g., computer system/server 502 (FIG. 5) on, or connected to, a user interface device (e.g., user interface device 310 (FIG. 3) and/or user interface device 410 (FIG. 4)). In some embodiments, the server is connected to a QA system. In some embodiments, the method 100 is implemented as a computer script or computer program (e.g., computer executable code) to be executed on or connected to a computer system (e.g., computer system 500 (FIG. 5)). In some embodiments, the computer system (e.g., computer system 500 (FIG. 5)) is a QA system.

Method 100 includes operation 110 to receive an input statement. In some embodiments, the input statement includes a plurality of natural language words. The input statement may be submitted as a natural language sentence, query, etc. by a user to a user interface device. The user interface device may transmit the natural language query (i.e., the input statement) to a system/server (e.g., a QA system). Thus, the input statement may be received, in some embodiments, from a user interface device. As discussed herein, the input statement may be submitted as a statement, as opposed to a question, for verification (for example, when a user wants to verify a statement). In some embodiments, the entire statement may be submitted as one input.

Method 100 includes operation 120 to determine one or more replacement candidates for the input statement. A replacement candidate may be a component (comprised of one or more natural language words) of the input statement that has a potential of being replaced. In some embodiments, the input statement is divided into a plurality of replacement candidates. For example, the input statement “The first man on the moon, Charles Lindbergh, landed at the Sea of Tranquility on Jul. 20, 1969” may be broken up into replacement candidates “first man on the moon,” “Charles Lindbergh,” “landed at,” “Sea of Tranquility,” and “Jul. 20, 1969.”

In some embodiments, the replacement candidates may be determined using classification types. Classification types may be categories, parts of speech, etc. that identify a sentence component's purpose in the sentence. Classification types may include types such as proper noun, person, location, date, fictional character, physical entity, etc. For example, in the input statement “The first man on the moon, Charles Lindbergh, landed at the Sea of Tranquility on Jul. 20, 1969,” “first man on the moon” may be classified as a person, “Charles Lindbergh” may be classified as a proper noun or a person (or both), “Sea of Tranquility” may be classified as a location, and “Jul. 20, 1969” may be classified as a date. In some embodiments, natural language processing, along with semantic and syntactic analysis, is used to determine the classification types.

Method 100 includes operation 130 to generate one or more candidate answers for each replacement candidate of the one or more replacement candidates. Candidate answers may be possible substitutions for the one or more replacement candidates. In some embodiments, one replacement candidate may have multiple candidate answers. For example, the replacement candidate “Charles Lindbergh” may have candidate answers such as “Neil Armstrong,” “Buzz Aldrin,” and “Michael Collins.” In some embodiments, a candidate answer for the replacement candidate may be the replacement candidate itself. For example, one of the candidate answers for “Charles Lindbergh” may be “Charles Lindbergh.”

In some embodiments, generating one or more candidate answers includes searching a data corpus for passages related to the input statement and the one or more replacement candidates. When the input statement is received by the system (e.g., a QA system), a data corpus (for example, on a database) may be queried in order to search for related passages. In some instances, the input statement is broken down into components (e.g., replacement candidates) and a query is done for each component and/or replacement candidate. By searching a data corpus, related documents or passages (related to the input statement and/or the replacement candidates) may be obtained. For example, a query performed on a data corpus using input statement “The first man on the moon, Charles Lindbergh, landed at the Sea of Tranquility on Jul. 20, 1969,” may result in related passages:

“Neil Armstrong and Buzz Aldrin landed, on Jul. 20, 1969, at the Sea of Tranquility.”

“Charles Lindbergh was the first transatlantic flight pilot and landed at Le Bourguet Field on May 21, 1927.”

“Neil Armstrong, Buzz Aldrin, and Michael Collins landed back on Earth on Jul. 24, 1969.”

In some embodiments, generating the one or more candidate answers includes analyzing the related passages. The related passages may be analyzed in order to determine the relation and the relevance of the related passages to the input statement, and the replacement candidates. In some instances, the related passages are analyzed by identifying any relationships between components of the related passages and the one or more replacement candidates. For example, the related passage “Neil Armstrong and Buzz Aldrin landed, on Jul. 20, 1969, at the Sea of Tranquility” may have multiple relationships to the various replacement candidates. For instance, “Neil Armstrong and Buzz Aldrin landed” may be related to “Charles Lindbergh, landed . . . ” Additionally, “on Jul. 20, 1969, at the Sea of Tranquility” may be related to “landed at the Sea of Tranquility on Jul. 20, 1969.” Analyzing the related passages may include determining any relation or relevance to the initial input statement and/or replacement candidates.

Analyzing the related passages may also include mapping each component of the related passages (that are related to the one or more replacement candidates) to its corresponding replacement candidate. Mapping, or maps, may refer to connections between data elements or structures. Mapping the related components of the passages to their corresponding replacement candidate may include creating, or establishing, a connection between the component and the corresponding replacement candidate. For example, the related passage, “Neil Armstrong and Buzz Aldrin landed, on Jul. 20, 1969, at the Sea of Tranquility,” may have multiple connections to the various replacement candidates. For instance, “Neil Armstrong” and “Buzz Aldrin” may be connected to the replacement candidate “Charles Lindbergh.” Additionally, “Jul. 20, 1969” may be connected to replacement candidate “Jul. 20, 1969” and “Sea of Tranquility” may be connected to the replacement candidate “Sea of Tranquility.” These connections may be mapped, for example, “Neil Armstrong” may be mapped to “Charles Lindbergh,” “Buzz Aldrin” may be mapped to “Charles Lindbergh,” “Jul. 20, 1969” may be mapped to “Jul. 20, 1969,” and “Sea of Tranquility” may be mapped to “Sea of Tranquility.”

In some embodiments, generating the one or more candidate answers includes identifying a classification type for each replacement candidate of the one or more replacement candidates. Identifying a classification type for each replacement candidate is discussed further above. In some embodiments, identifying relationships between components of the related passages is based on at least the classification type for each replacement candidate and a classification type for each component. For instance, a replacement candidate that is classified as a name may not be related to a component that is classified as a date. In some embodiments, identifying any relationships may include identifying replacement candidates and components (of the related passage(s)) with the same classification type. Examples of classification types may include proper noun, person, location, date, fictional character, physical entity, etc.

In some embodiments, generating the one or more candidate answers includes generating, based on the analyzing, the one or more candidate answers for each replacement candidate. As discussed herein, candidate answers may be possible substitutions for the one or more replacement candidates. In some embodiments, the candidate answers are the identified related passage components. For example, “Neil Armstrong” may be a candidate answer for the replacement candidate “Charles Lindbergh.” In some embodiments, one replacement candidate may have multiple candidate answers. For example, “Charles Lindbergh” may also have a candidate answer “Buzz Aldrin.”

Method 100 includes operation 140 to map each candidate answer to its corresponding replacement candidate. In some embodiments, the candidate answer and its corresponding replacement candidate have already been mapped when generating the one or more candidate answers. In some embodiments, the candidate answer is mapped to its corresponding replacement candidate (referred to herein as a replacement candidate—candidate answer mapping) after the candidate answers for each replacement candidate have been generated.

Mapping, or maps, as discussed herein, may refer to connections between data elements or structures. Mapping the candidate answer to its corresponding replacement candidate may include creating, or establishing, a connection between the candidate answer and the corresponding replacement candidate. For example, the related passage “Neil Armstrong and Buzz Aldrin landed, on Jul. 20, 1969, at the Sea of Tranquility” may have multiple connections to the various replacement candidates. These connections may be mapped. For example, “Neil Armstrong” may be mapped to “Charles Lindbergh,” “Buzz Aldrin” may be mapped to “Charles Lindbergh,” “Jul. 20, 1969” may be mapped to “Jul. 20, 1969,” and “Sea of Tranquility” may be mapped to “Sea of Tranquility.”

Method 100 includes operation 150 to determine a replacement score for each replacement candidate—candidate answer mapping. The replacement score may indicate confidence in the accuracy of the statement with the replacement candidate replaced with the candidate answer. For example, replacing “Charles Lindbergh” (replacement candidate) with “Neil Armstrong” (candidate answer) in the statement “the first man on the moon, Charles Lindbergh, landed at the Sea of Tranquility on Jul. 20, 1969” may have a 0.98 replacement score. The 0.98 replacement score may indicate that the system is 98% confident that the statement “the first man on the moon, Neil Armstrong, landed at the Sea of Tranquility on Jul. 20, 1969.” The high replacement score (in this example the highest possible score is 1.00) may indicate that the statement “the first man on the moon, Neil Armstrong, landed at the Sea of Tranquility on Jul. 20, 1969,” with the candidate answer replacing the replacement candidate, is highly accurate. In some embodiments, the replacement score for this example may be 1.00, because the statement is completely accurate. In some embodiments, although the highest possible score is 1.00, the system may always factor in a small buffer for unforeseen error, and a 0.98 replacement score may indicate that the statement is completely accurate, with a 0.02 buffer for unforeseen error.

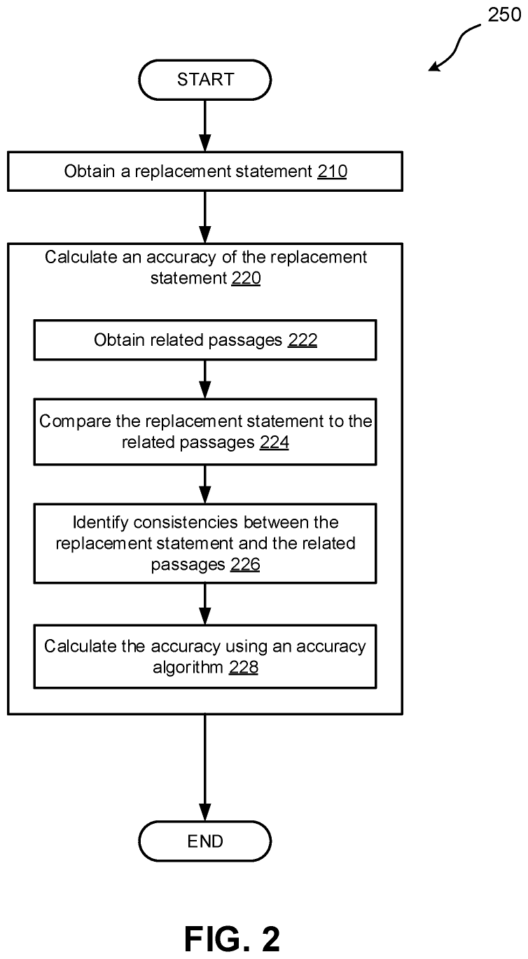

The replacement score may be a decimal, an integer, a percentage, etc. In some instances, the replacement score may correspond with the accuracy of the statement. Thus, the higher the replacement score, the more accurate the statement may be if modified with the candidate answer. Determining a replacement score is further discussed herein and is depicted in FIG. 2. In some embodiments, operation 150 corresponds with method 250 of FIG. 2.

In some embodiments, a plurality of replacement candidates and candidate answer mapping may be combined. For example, man on the moon mapped to transatlantic flight pilot, Sea of Tranquility mapped to Le Bourguet Field, and Jul. 20, 1969 mapped to May 21, 1927 may all be combined into a single complex mapping. The replacement score for the combined plurality of replacement candidates and corresponding candidate answers may indicate the accuracy of the statement if all the candidate answers replace their corresponding replacement candidates. For example, continuing the above example, “the first man on the moon, Charles Lindbergh, landed at the Sea of Tranquility on Jul. 20, 1969” may be replaced, or substituted, to “the first transatlantic flight pilot, Charles Lindbergh, landed at the Le Bourguet Field on May 21, 1927.” This statement may have a replacement score of 0.98 in this example.

In some embodiments, the difficulty of the replacement is considered when determining the replacement score. This may be referred to as a weighted replacement score. For instance, a replacement with a candidate answer that is simply substituting one word, or a couple words, from the input statement may have a low difficulty of replacement. But, in other instances such as the example above, many candidate answers may be replacing many replacement candidates, which may have a high, or relatively higher, difficulty of replacement because so many words are being replaced. If difficulty of the replacement is considered, the above example may have a weighted replacement score of 0.60 instead of 0.98 to reflect the difficulty of the replacement along with the accuracy of the resulting statement.

Method 100 includes operation 160 to transmit an output including one or more suggested replacements and their corresponding replacement score to a user interface. The suggested replacements may include the replacement candidate and its corresponding candidate answer, in some embodiments. In some embodiments, the output is transmitted to the user interface that the input statement was received from. An example output is depicted in FIG. 4 and discussed further herein.

In some embodiments, a candidate answer is equal to the input statement. For example, a candidate answer of the input statement “the first man on the moon, Charles Lindbergh, landed at the Sea of Tranquility on Jul. 20, 1969” may be “the first man on the moon, Charles Lindbergh, landed at the Sea of Tranquility on Jul. 20, 1969.” When the candidate answer is equal to the input statement, a “YES” may be displayed (e.g., as depicted in line 7 of the output area 426 (FIG. 4)). The “YES” may indicate that the statement is true. In some embodiments, a replacement score for a “YES” replacement may indicate the accuracy of an input statement if the input statement remains the same. In the FIG. 4 example (line 7 of the output area 426), there is only a 0.01 replacement score for the input statement remaining the same, which may indicate that the input statement is not accurate.

In some embodiments, the output displays the one or more suggested replacements in order of replacement score. For example, the highest replacement score (for example, indicating that the statement with the candidate answer replacement is accurate) is at the top of the output list, and the lowest replacement score is displayed at the bottom of the output list. In some embodiments, only the top few replacement scores (and their corresponding suggested replacement) are included in the output. For example, the top 3, 5, 10, etc. replacement scores may be included in the output.

Referring to FIG. 2, a flowchart illustrating a method 250 for determining a replacement score for each corresponding replacement candidate and candidate answer is depicted, according to some embodiments. In some embodiments, method 250 is executed by a server (e.g., computer system/server 502 (FIG. 5) on, or connected to, a user interface device (e.g., user interface device 310 (FIG. 3) and/or user interface device 410 (FIG. 4)). In some embodiments, the server is connected to a QA system. In some embodiments, the method 250 is implemented as a computer script or computer program (e.g., computer executable code) to be executed on or connected to a computer system (e.g., computer system 500 (FIG. 5)). In some embodiments, the computer system (e.g., computer system 500 (FIG. 5)) is a QA system. In some embodiments, method 250 corresponds to operation 150 (FIG. 1).

Method 250 includes operation 210 to obtain a replacement statement. The replacement statement may be the input statement with the replacement candidate replaced by the candidate answer. Obtaining the replacement statement may include replacing the replacement candidate with the candidate answer in the input statement. Once the replacement statement is obtained, method 250 proceeds to operation 220 to calculate an accuracy of the replacement statement. The accuracy of the replacement statement may be indicated by the replacement score, in some embodiments. In some embodiments, as depicted in FIG. 2, calculating an accuracy of the replacement statement includes obtaining related passages (operation 222), comparing the replacement statement to the related passages (operation 224), identifying consistencies between the replacement statement and the related passages (operation 226), and calculating the accuracy using an accuracy algorithm (228). The related passages may be obtained from a data corpus and may be related to the input statement and the one or more replacement candidates, as discussed herein. Once the related passages are obtained, the passages may be compared to the replacement statement and consistencies between the replacement statement and the related passages may be identified (based on the comparing).

In some embodiments, a degree of relatedness in considered when comparing the related passages to the replacement statement. The degree of relatedness may be an overall relationship, or relatedness, between the related passages and the replacement statement. The degree of relatedness may be indicated by an integer, a decimal, a percent, a level, etc. For instance, a replacement statement that has little to no relation to any of the related passages may have a low degree of relatedness. In some instances, a replacement statement that has a relation to all of the related passages may have a very high degree of relatedness. In some instances, a replacement statement has a relation to the majority of related passages but may have no relation to a small part of the related passages. In this instance, the degree of relatedness may be high but, for example, may not be quite as high as the degree of relatedness between a replacement statement and the related passages. The degree of relatedness may still be high, though, because the small amount of related passages that have no relation to the replacement statement may have been related to the replacement candidate that was replaced by the candidate answer.

For example, the replacement statement “the first man on the moon, Neil Armstrong, landed at the Sea of Tranquility on Jul. 20, 1969” may be compared to the related passages:

“Neil Armstrong and Buzz Aldrin landed, on Jul. 20, 1969, at the Sea of Tranquility.”

“Charles Lindbergh was the first transatlantic flight pilot and landed at Le Bourguet Field on May 21, 1927.”

“Neil Armstrong, Buzz Aldrin, and Michael Collins landed back on Earth on Jul. 24, 1969.”

In this example, the replacement statement is consistent with the first related passage indicating that Neil Armstrong was one of the people who landed at the Sea of Tranquility on Jul. 20, 1969. The replacement statement does not have any relation to the second related passage. The replacement statement is also related to the third related passage, which states that Neil Armstrong landed back on Earth (indicating that Neil Armstrong left Earth, which is consistent with the replacement statement). Because the replacement statement has a strong relation to the majority of the related passages, the replacement statement may have a high degree of relatedness. The lack of relation to the second related passage may decrease the degree of relatedness, but because the second related passage is related to the replacement candidate, it may not have a large effect on the degree of relatedness.

The accuracy of the replacement statement may be calculated (in operation 228) based on the consistencies and using an accuracy algorithm. For instance, the accuracy algorithm may weight each consistency and inconsistency between the replacement statement and the related passages and may calculate the accuracy based on the weights. For example, if a replacement statement is almost entirely consistent with the related passages, the consistencies may be given a high weight, and any inconsistencies may be given a lower weight. In some instances, a replacement statement may only be partially consistent with the related passages. When there is a partial inconsistency, the consistencies and inconsistencies may be given a similar weight, in some embodiments. In some instances, a replacement may be primarily inconsistent with the related passages. In this instance, the inconsistencies may be given a higher weight in order to highlight the inconsistencies between the replacement statement and the related passages.

In some instances, the accuracy algorithm may consider how significantly the statement has changed from the input statement and/or the difficulty of the replacement. If the replacement statement is only a word or a couple words different from the input statement (i.e., the candidate answer is small), the replacement statement may not have changed much from the input statement and may have a low difficulty of replacement. In this instance, the replacement statement may have a high weighted replacement score (for example, a replacement score that considers the difficulty of replacement) because it is very similar to the input statement. In some embodiments, the replacement statement may be significantly changed from the input statement.

For example, the input statement “the first man on the moon, Charles Lindbergh, landed at the Sea of Tranquility on Jul. 20, 1969” may have a replacement statement “the first transatlantic flight pilot, Charles Lindbergh, landed at the Le Bourguet Field on May 21, 1927.” The replacement statement may be accurate, so it may have a high un-weighted replacement score, but because the changes are so significant (compared to the input statement) the replacement statement may have a lower weighted replacement score. The weighted replacement score may help identify the actual verification a user is looking for. For instance, using the above example, it may not be very likely that the user would like verification that Charles Lindbergh was the first transatlantic flight pilot, so this replacement statement may have a lower weight. But, a replacement statement indicating that “the first man on the moon, Neil Armstrong, landed at the Sea of Tranquility on Jul. 20, 1969” may be the verification, or at least close to the verification, that a user is looking for.

Referring to FIG. 3, a schematic diagram of a factoid QA system environment 300 is depicted, according to some embodiments. The QA system environment 300 includes a user interface device 310 and a QA system 320. In some embodiments, as depicted, the QA system includes a question processing module 321, a document analysis module 323, an answer processing module 325, a scoring module 327, and an output generator module 329. QA system environment 300 may be used to execute method 100 (FIG. 1), in some embodiments. In some embodiments, the question processing module 321 is used to execute at least operation 110 of FIG. 1. An input question may be inputted into user interface device 310 and transmitted to question processing module 321. In some embodiments, the document analysis module 323 executes at least operations 120 and 130 of FIG. 1. In some embodiments, answer processing module 325 executes operation 140 of FIG. 1. In some embodiments, answer processing module 325 also executes operation 130 of FIG. 1. In some embodiments, operation 150 of FIG. 1 is executed by scoring module 327 and operation 160 of FIG. 1 is executed by output generator module 329. Output generator 329 may transmit the output with the suggested replacements and replacement scores to the user interface device 310.

In some embodiments, various components of QA system 320 may be combined or merged together. For example, answer processing module 325 and scoring module 327 may be combined into a single module in some instances.

Referring to FIG. 4, a schematic diagram of a user interface environment 400 displaying suggested substitute components is depicted, according to some embodiments. The user interface environment includes a user interface device 410 and a user interface display 420a on the user interface device 410. In some embodiments, the user interface display 420a may be connected to the user interface device 410. The user interface display 420a is zoomed in (420b) in order to show what is being displayed on the user interface display 420. The user interface display 420a and the zoomed in user interface display 420b may be collectively referred to as user interface display 420. Using the previous example, discussed herein, a user may input “The first man on the moon, Charles Lindbergh, landed at the Sea of Tranquility on Jul. 20, 1969” in the input area 422 on the user interface display 420.

Once the input statement has been inputted, it may be transmitted to a QA system (e.g., QA system 320 (FIG. 3)) for processing. The QA system may perform method 100 (FIG. 1), in some embodiments. In some embodiments, as discussed herein, the QA system may identify any relevant documents from a corpus that may support or contradict the statement. For example, for the above statement, the corpus may return relevant documents or phrases including:

“Neil Armstrong and Buzz Aldrin landed, on Jul. 20, 1969, at the Sea of Tranquility.”

“Charles Lindbergh was the first transatlantic flight pilot and landed at Le Bourguet Field on May 21, 1927.”

“Neil Armstrong, Buzz Aldrin, and Michael Collins landed back on Earth on Jul. 24, 1969.”

These statements may be analyzed in order to determine whether any replacements/substitutions are needed for the original input statement. Based on the analysis, the QA system may output suggested substitutions, along with accuracy scores of the suggested substitutions. Based on the above example relevant documents/phrases, the QA system may output substitutions such as:

1. Charles Lindbergh→Neil Armstrong (0.98)

2. Charles Lindbergh→Buzz Aldrin (0.92)

3. man on the moon→transatlantic flight pilot (0.70)

4. Sea of Tranquility→Le Bourguet Field (0.55)

5. Jul. 20, 1969→May 21, 1927 (0.53)

6. Jul. 20, 1969→Jul. 24, 1969 (0.22)

7. YES (0.01)

8. Charles Lindbergh→Michael Collins (0.01)

These outputs may be transmitted to the user interface device 410 and may be displayed in the output area 426 of the user interface display 420. Based on the example outputs, it may be determined that the initial statement, “The first man on the moon, Charles Lindbergh, landed at the Sea of Tranquility on Jul. 20, 1969” was not fully accurate, and, to make the statement accurate, Charles Lindbergh may be replaced with Neil Armstrong, or for slightly less accuracy, Buzz Aldrin. In some embodiments, recommended substitutions 3 through 5 may be merged as a single substitution. For example, substitution 3 may include:

3. man on the moon→transatlantic flight pilot; Sea of Tranquility→Le Bourguet Field; Jul. 20, 1969→May 21, 1927 (0.95)

This may indicate that if man on the moon, Sea of Tranquility, and Jul. 20, 1969 are all replaced with their corresponding substitutions, the resulting statement may have a 0.95, or 95%, accuracy. Replacing these elements may result in a replacement statement of “The first transatlantic flight pilot, Charles Lindbergh, landed at the Le Bourguet Field on May 21, 1927.” In some embodiments, because the replacement statement has significantly changed from the input statement, the substitution corresponding to the significantly changed replacement statement may be flagged. Continuing the above example, the substitution “3. man on the moon→transatlantic flight pilot; Sea of Tranquility→Le Bourguet Field; Jul. 20, 1969→May 21, 1927 (0.95)” may be flagged. In some instances, a weighted replacement score may be used in order to consider any changes, particularly significant changes, between the replacement statement and the input statement. In this example, because the replacement statement has significantly changed from the input statement, the weighted replacement score may be lower, for example 0.60, to indicate the significance and the difficulty of the change.

In some instances, output area 426 may include, for each recommended substitution, a link to the supporting passages that the substitution is derived from. For example, “Neil Armstrong,” the entire substation line “1. Charles Lindbergh→Neil Armstrong (0.98),” or any portion of the substitution line, may include a hyperlink linking to the passage(s) including the statement “Neil Armstrong and Buzz Aldrin landed, on Jul. 20, 1969, at the Sea of Tranquility.”

Referring to FIG. 5, computer system 500 is a computer system/server 502 is shown in the form of a general-purpose computing device, according to some embodiments. In some embodiments, computer system/server 502 is located on the linking device. In some embodiments, computer system 502 is connected to the linking device. The components of computer system/server 502 may include, but are not limited to, one or more processors or processing units 510, a system memory 560, and a bus 515 that couples various system components including system memory 560 to processor 510.

Bus 515 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media.

System memory 560 can include computer system readable media in the form of volatile memory, such as random-access memory (RAM) 562 and/or cache memory 564. Computer system/server 502 may further include other removable/non-removable, volatile/non-volatile computer system storage media. By way of example only, storage system 565 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 515 by one or more data media interfaces. As will be further depicted and described below, memory 560 may include at least one program product having a set (e.g., at least one) of program modules that are configured to carry out the functions of embodiments of the disclosure.

Program/utility 568, having a set (at least one) of program modules 569, may be stored in memory 560 by way of example, and not limitation, as well as an operating system, one or more application programs, other program modules, and program data. Each of the operating system, one or more application programs, other program modules, and program data or some combination thereof, may include an implementation of a networking environment. Program modules 569 generally carry out the functions and/or methodologies of embodiments of the invention as described herein.

Computer system/server 502 may also communicate with one or more external devices 540 such as a keyboard, a pointing device, a display 530, etc.; one or more devices that enable a user to interact with computer system/server 502; and/or any devices (e.g., network card, modem, etc.) that enable computer system/server 502 to communicate with one or more other computing devices. Such communication can occur via Input/Output (I/O) interfaces 520. Still yet, computer system/server 502 can communicate with one or more networks such as a local area network (LAN), a general wide area network (WAN), and/or a public network (e.g., the Internet) via network adapter 550. As depicted, network adapter 550 communicates with the other components of computer system/server 502 via bus 515. It should be understood that although not shown, other hardware and/or software components could be used in conjunction with computer system/server 502. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electronic signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object orientated program language such as Smalltalk, C++, or the like, and procedural programming languages, such as the “C” programming language or similar programming languages. The computer readable program instructions may execute entirely one the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to some embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving an input statement, wherein the input statement comprises a plurality of natural language words;
determining one or more replacement candidates for the input statement;
generating one or more candidate answers for each replacement candidate of the one or more replacement candidates;
mapping, as a replacement candidate—candidate answer mapping, each candidate answer from the one or more candidate answers to its corresponding replacement candidate;
determining a replacement score for each replacement candidate—candidate answer mapping; and
transmitting an output comprising one or more suggested replacements and the replacement score to a user interface, wherein the suggested replacement corresponds at least the replacement candidate and its corresponding candidate answer.

2. The method of claim 1, wherein determining the replacement score for each replacement candidate—candidate answer mapping comprises, for each replacement candidate—candidate answer mapping:
obtaining a replacement statement, wherein the replacement statement is the input statement with the replacement candidate replaced by the candidate answer; and
calculating an accuracy of the replacement statement, wherein a confidence in the accuracy is indicated by the replacement score.

3. The method of claim 2, wherein calculating the accuracy of the replacement statement comprises:
obtaining related passages, wherein the related passages are related to the input statement and the one or more replacement candidates, from a data corpus;
comparing the replacement statement to the related passages;
identifying, based on the comparing, consistencies between the replacement statement and the related passages; and
calculating the accuracy, based on the consistencies, using an accuracy algorithm.

4. The method of claim 2, further comprising:
determining a difficulty of replacement for the replacement statement; and
calculating a weighted replacement score based on the accuracy of the replacement statement and the difficulty of replacement.

5. The method of claim 1, further comprising:
combining a plurality of replacement candidate—candidate answer mappings; and
determining a suggested replacement comprising a plurality of replacement candidates and corresponding candidate answers.

6. The method of claim 1, wherein generating one or more candidate answers comprises:
searching a data corpus for passages related to the input statement and the one or more replacement candidates;
analyzing the related passages;
generating, based on the analyzing, the one or more candidate answers for each replacement candidate.

7. The method of claim 6, wherein analyzing the related passages comprises:
identifying any relationships between components of the related passages and the one or more replacement candidates; and
mapping each component of the related passages that are related to the one or more replacement candidates to its corresponding replacement candidate.

8. The method of claim 7, further comprising:
identify a classification type for each replacement candidate of the one or more replacement candidates.

9. The method of claim 8, wherein the identifying any relationships between components of the related passages is based on at least the classification type for each replacement candidate and a classification type for each component.

10. The method of claim 8, wherein the classification type includes at least one of:
proper noun, person, location, date, fictional character, and physical entity.

11. The method of claim 1, further comprising:
determining that a candidate answer from the one or more candidate answers is equal to its corresponding replacement candidate; and
replacing a replacement, from the one or more corresponding replacements, corresponding to the candidate answer equal to the replacement candidate with YES on the transmitted output.

12. A system having one or more computer processors, the system configured to:
receive an input statement, wherein the input statement comprises a plurality of natural language words;
determine one or more replacement candidates for the input statement;
generate one or more candidate answers for each replacement candidate of the one or more replacement candidates;
map, as a replacement candidate—candidate answer mapping, each candidate answer from the one or more candidate answers to its corresponding replacement candidate;
determine a replacement score for each replacement candidate—candidate answer mapping; and
transmit an output comprising one or more suggested replacements and the replacement score to a user interface, wherein the suggested replacement corresponds at least the replacement candidate and its corresponding candidate answer.

13. The system of claim 12, wherein determining the replacement score for each replacement candidate—candidate answer mapping comprises, for each replacement candidate—candidate answer mapping:
obtaining a replacement statement, wherein the replacement statement is the input statement with the replacement candidate replaced by the candidate answer; and
calculating an accuracy of the replacement statement, wherein the accuracy is indicated by the replacement score.

14. The system of claim 13, wherein calculating the accuracy of the replacement statement comprises:
obtaining related passages, wherein the related passages are related to the input statement and the one or more replacement candidates, from a data corpus;
comparing the replacement statement to the related passages;
identifying, based on the comparing, consistencies between the replacement statement and the related passages; and
calculating the accuracy, based on the consistencies, using an accuracy algorithm.

15. The system of claim 12, wherein generating one or more candidate answers comprises:
searching a data corpus for passages related to the input statement and the one or more replacement candidates;
analyzing the related passages;
generating, based on the analyzing, the one or more candidate answers for each replacement candidate.

16. The system of claim 15, wherein analyzing the related passages comprises:
identifying any relationships between components of the related passages and the one or more replacement candidates; and
mapping each component of the related passages that are related to the one or more replacement candidates to its corresponding replacement candidate.

17. A computer program product comprising a computer readable storage medium having program instructions embodied therewith, the program instructions executable by a server to cause the server to perform a method, the method comprising:
receiving an input statement, wherein the input statement comprises a plurality of natural language words;
determining one or more replacement candidates for the input statement;
generating one or more candidate answers for each replacement candidate of the one or more replacement candidates;
mapping, as a replacement candidate—candidate answer mapping, each candidate answer from the one or more candidate answers to its corresponding replacement candidate;
determining a replacement score for each replacement candidate—candidate answer mapping; and
transmitting an output comprising one or more suggested replacements and the replacement score to a user interface, wherein the suggested replacement corresponds at least the replacement candidate and its corresponding candidate answer.

18. The computer program product of claim 17, wherein determining the replacement score for each replacement candidate—candidate answer mapping comprises, for each replacement candidate—candidate answer mapping:
obtaining a replacement statement, wherein the replacement statement is the input statement with the replacement candidate replaced by the candidate answer; and
calculating an accuracy of the replacement statement, wherein the accuracy is indicated by the replacement score.

19. The computer program product of claim 18, wherein calculating the accuracy of the replacement statement comprises:
obtaining related passages, wherein the related passages are related to the input statement and the one or more replacement candidates, from a data corpus;
comparing the replacement statement to the related passages;
identifying, based on the comparing, consistencies between the replacement statement and the related passages; and
calculating the accuracy, based on the consistencies, using an accuracy algorithm.

20. The computer program product of claim 17, wherein generating one or more candidate answers comprises:
searching a data corpus for passages related to the input statement and the one or more replacement candidates;
analyzing the related passages;
generating, based on the analyzing, the one or more candidate answers for each replacement candidate.
